(19) United States
(12) Patent Application Publication
(10) Pub. No.: US 2025/0013801 A1
(43) Pub. Date: Jan. 9, 2025

(54) METHOD FOR STRENGTHENING SHEAR STRENGTH OF RC BEAM WITH COMPRESSED STEEL BAR

(71) Applicant: SHENZHEN UNIVERSITY, Shenzhen (CN)

(72) Inventors: Yufei WU, Shenzhen (CN); Fang YUAN, Shenzhen (CN)

(21) Appl. No.: 18/219,569

(22) Filed: Jul. 7, 2023

(51) Int. Cl. G06F 30/20

(52) U.S. Cl. CPC G06F 30/20; G06F 2111/10

(57) ABSTRACT

The disclosure discloses a method for strengthening shear strength of a RC beam with a compressed steel bar, including step one: analyzing and concluding that the compressed steel bar has a positive effect of on shear strength of the RC beam via experimental testing and/or establishing a truss model; step two: carrying out a finite element simulation; step three: comparing a result obtained by the finite element simulation with that obtained by the experimental testing, to verify a reliability of the finite element model; step four: systematically researching a comprehensive impact of a reinforcement ratio of the compression steel bar, a stirrup ratio ρₛᵥ, a reinforcement ratio ρₛₜ of a tensile longitudinal steel bar, a shear span ratio/and a concrete strength grade (f_{co}) on the shear strength of beam; and step five: obtaining a mathematical model of an increment of shear strength via regression analysis.

### TECHNICAL FIELD

The disclosure relates to the technical field of shear strength calculation of a reinforced concrete (RC) beam, and in particular to a method for strengthening shear strength of a RC beam with a compressed steel bar.

### BACKGROUND

The RC beam is a reinforced concrete beam, and the shear strength of a RC beam consists of the strength provided by a transverse reinforcement (Vₛ) and a concrete (V_{c}), and the shear strength (V) of the RC beam is the sum of the shear strength components of the transverse reinforcement (Vₛ) and the concrete (V_{c}). This superposition method has been widely used in the existing design specifications.

However, the existing shear strength model does not consider the contribution of compressed steel bar. There is little discussion about the effect of compressed steel baron the shear strength of RC member in various literatures. Based on this, in order to improve the accuracy of the calculation model of shear strength of the RC beam, a method for strengthening the shear strength of the RC beam with compressed steel bar is urgently needed.

### SUMMARY

The objectives of the present disclosure are to provide a method for strengthening shear strength of a RC beam with a compressed steel bar, so as to solve the problems existing in the prior art and realize the calculation of the increment of shear strength caused by the compressed steel bar.

In order to achieve the above objectives, the present disclosure provides the following scheme.

The disclosure provides a method for strengthening shear strength of a RC beam with a compressed steel bar, including:
step one: analyzing and concluding that the compressed steel bar has a positive effect on the shear strength of the RC beam via experimental testing and/or establishing a truss model;
step two: establishing a finite element model using simulation software in a computer, and carrying out a finite element simulation;
step three: comparing a result obtained by the finite element simulation with that obtained by the experimental testing, so as to verify a reliability of the finite element model;
step four: performing a systematical research about a comprehensive impact of a reinforcement ratio ρ_{sc} of the compressed steel bar, a stirrup ratio ρₛᵥ a reinforcement ratio ρₛₜ of a tensile longitudinal steel bar, a shear span ratio λ and a concrete strength grade f_{co} on the shear strength of a beam, via analyzing numerical parameter; and
step five: obtaining a mathematical model of an increment of the shear strength via regression analysis based on a numerical simulation result in the step four.

Preferably, in the step five, the increment of the shear strength caused by the compressed steel bar is significantly affected by two factors: the reinforcement ratio ρ_{sc} of the compressed steel bar and the shear span ratio λ, and other factors are ignored; and the mathematical model of the increment of the shear strength affected by the reinforcement ratio ρ_{sc} of the compressed steel bar and the shear span ratio λ is obtained via regression analysis.

Preferably, in the step five, the mathematical model of the increment of the shear strength is:

$${V}_{sc} = {48.32}_{SC} ( - {λ}^{2} + 5.14 λ - 5.78 ) {b}_{w} d \geq 0$$

in this formula:
V_{sc} is the increment of the shear strength;
λ is the shear span ratio;
ρ_{sc} is the reinforcement ratio of the compressed steel bar;
b_{w} is an effective width of the beam; and
d is an effective height of the beam.

Preferably, in the step two, the used simulation software is Abaqus software.

Preferably, in the step four, a control variable method is used in the systematic research, when one factor is considered, other factors remain unchanged.

Preferably, in the step four, the reinforcement ratio ρ_{sc} of the compressed steel bar ranges from 0 to 3.49%, the stirrup ratio ρₛᵥ ranges from 0 to 0.5%, the shear span ratio λ ranges from 1.9 to 3.1, the concrete strength grade f_{co} ranges from 20 to 50 MPa, and the reinforcement ratio ρₛₜ of the tensile longitudinal steel bar ranges from 3% to 4.5%.

Compared with the prior art, the disclosure has the following technical effects.

According to the disclosure, it is analyzed and concluded that the compressed steel bar have the positive effect on shear strength of a RC beam via experimental testing and/or establishing a truss model; and systematic parameterization research is conducted, it is determined that the comprehensive impact of the shear strength affected by the reinforcement ratio of the compressed steel bar and other key factors, including the stirrup ratio, the reinforcement ratio of the tensile longitudinal steel bar, the shear span ratio and the concrete strength grade. Finally, the new model of additional shear strength of the compressed steel bar is established.

### BRIEF DESCRIPTION OF THE DRAWINGS

In order to explain the technical scheme in the embodiments of the present disclosure or the prior art more clearly, the drawings needed in the embodiments will be briefly introduced below. Obviously, the drawings described below are only some embodiments of the present disclosure, and other drawings can be obtained according to these drawings without creative effect for ordinary people in the art.

FIG. 1 is a schematic diagram of a stress analysis of a truss model in step one;

FIG. 2 is a schematic diagram of an arrangement of steel bars of four beam specimens in series II of a step of experimental testing in the step one;

FIG. 3 is a schematic diagram of a three-point bending test;

FIGS. 4A-4F show a failure mode and crack morphology of the beam specimens;

FIGS. 5A-5B are diagrams of shear-deflection curves drawn according to a test result;

FIG. 6 is a finite element model of simply supported beam;

FIGS. 7B-7G are comparison diagrams of failure modes of a finite element simulation result and a test result;

FIGS. 8A-8B are comparison diagrams of shear-deflection curves of a test result and a finite element simulation result;

FIGS. 9A-9H are schematic diagrams of an effect of different reinforcement ratios of the compression steel bars on a longitudinal strain profile of concrete under peak load of beams; and

FIGS. 10A-10D are schematic diagrams of an effect of different parameters on shear strengths of beams with different reinforcement ratios of the compression steel bars.

Numerals in the drawings: 1—support frame; 2—hydraulic jack; 3—beam specimen; 4—support.

In FIG. 2: 2T8 means two steel bars with a diameter of 8 mm; 3T20 means three steel bars with a diameter of 20 mm; and 3T25 means three steel bars with a diameter of 25 mm.

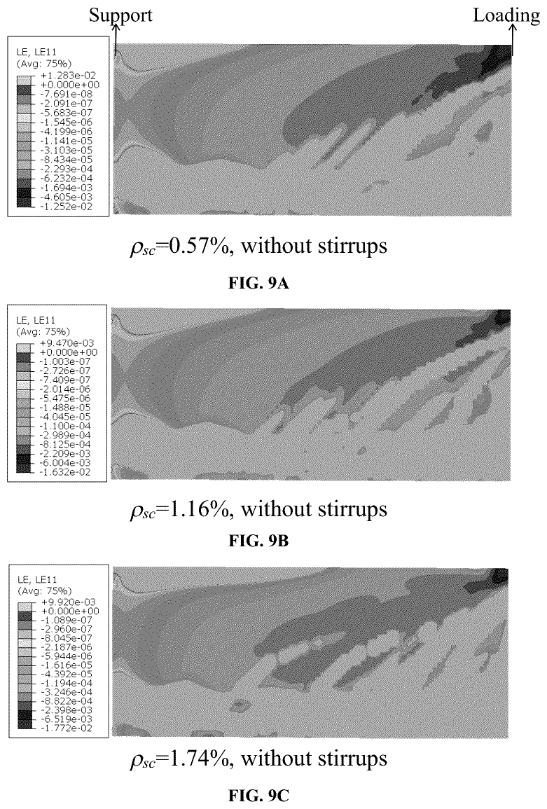

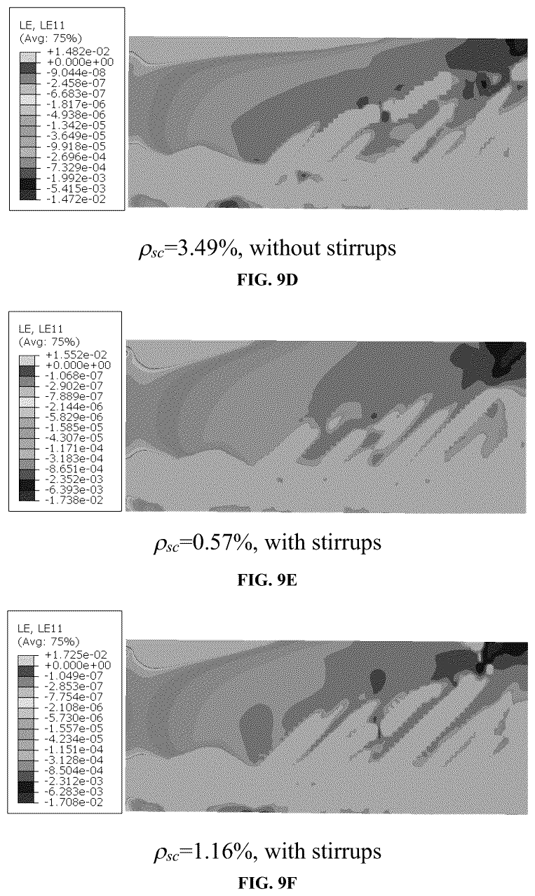

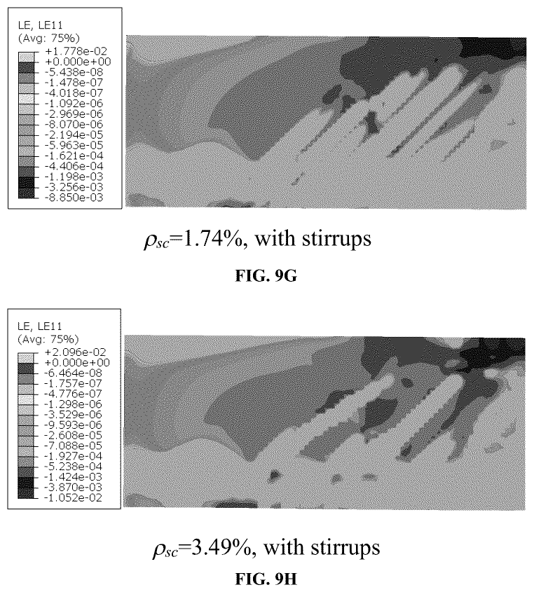

In FIG. 9A: the beam ρ_{sc} is 0.57%, without stirrups; in FIG. 9B: the beam ρ_{sc} is 1.16%, without stirrups; in FIG. 9C: the beam ρ_{sc} is 1.74%, without stirrups; in FIG. 9D the beam ρ_{sc} is 3.49%, without stirrups; in FIG. 9E: the beam ρ_{sc} is 0.57%, with stirrups; in FIG. 9F: the beam ρ_{sc} is 1.16%, with stirrups; in FIG. 9G: the beam ρ_{sc} is 1.74%, with stirrups; and in FIG. 9H the beam ρ_{sc} is 3.49%, with stirrups.

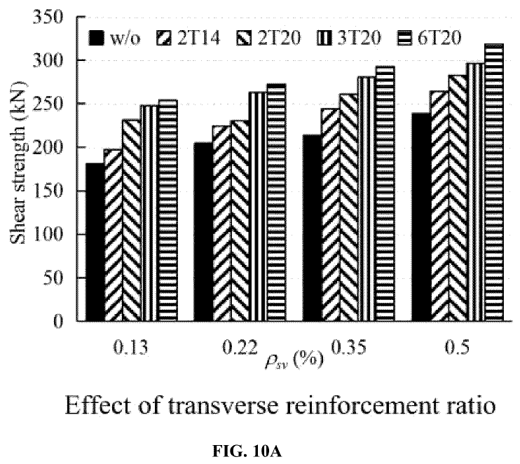

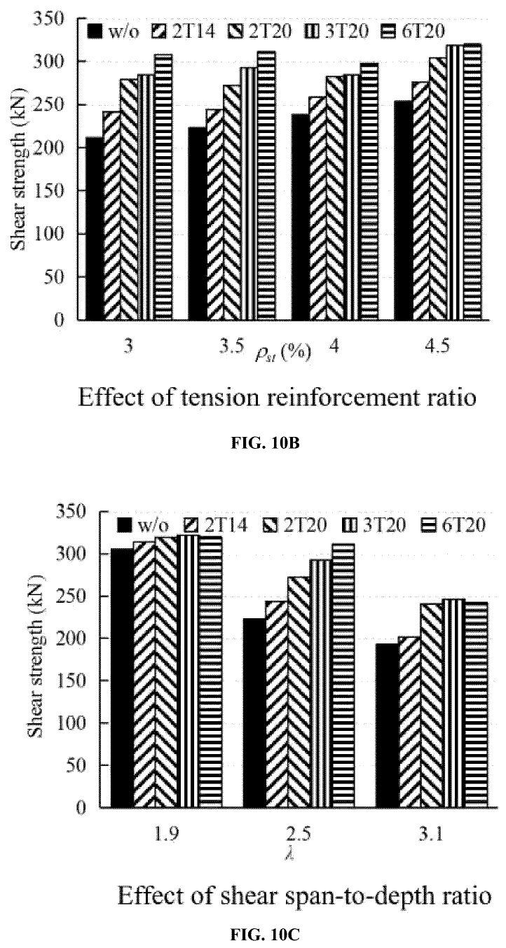

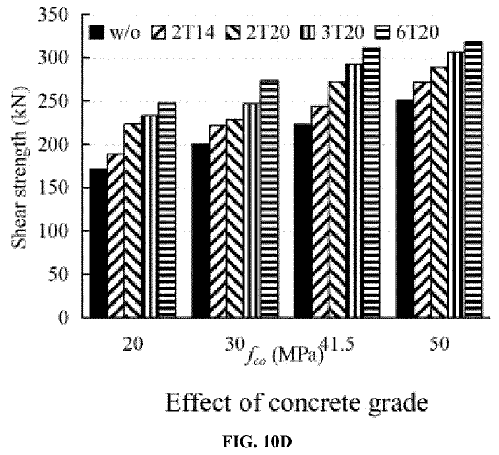

FIG. 10A is a schematic diagram showing the effect of different transverse reinforcement ratios on the shear strength of beams with different reinforcement ratios of the compression steel bars; FIG. 10B is a schematic diagram showing the effect of different tension reinforcement ratios on the shear strengths of beams with different reinforcement ratios of the compressed steel bars; FIG. 10C is a schematic diagram showing the effect of different shear span ratios on the shear strengths of beams with different reinforcement ratios of the compressed steel bars; and FIG. 10D is a schematic diagram showing the effect of different concrete grades on the shear strengths of beams with different reinforcement ratios of the compressed steel bars.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiments of the disclosure, but not the whole embodiment. Based on the embodiments in the present disclosure, all other embodiments obtained by those skilled in the art without creative effect belong to the scope of the present disclosure.

The objectives of the present disclosure are to provide a method for shear strength of a RC beam with a compressed steel bar, so as to solve the problems existing in the prior art and realize the calculation of increment of the shear strength caused by the compressed steel bar.

In order to make the above objectives, features and advantages of the present disclosure more obvious and easy to understand, the present disclosure will be further described in detail with the attached drawings and specific embodiments.

The disclosure provides a method for strengthening shear strength of a RC beam with a compressed steel bar, including:
step one: analyzing and concluding that of the compressed steel bar has a positive effect on the shear strength of the RC beam via experimental testing and/or establishing a truss model;
step two: establishing a finite element model using simulation software in a computer, and carrying out finite element simulation, the used simulation software is Abaqus software, and the material and contact module library in Abaqus software contains a constitutive model of concrete, steel bar and concrete-steel interface needed for analysis;
step three: comparing a result obtained by the finite element simulation with that obtained by the experimental testing, so as to verify a reliability of the finite element model;
step four: via analyzing numerical parameters, systematically researching a comprehensive impact of reinforcement ratios of compression steel bars, different stirrup ratios (ρₛᵥ), different reinforcement ratios (ρₛₜ) of tensile longitudinal steel bars, different shear span ratios (λ) and different concrete strength grades (f_{co}) on the shear strength of the RC beam. Specifically, a control variable method is used in the systematically research, when one factor is considered, other factors remain unchanged, the reinforcement ratio ρ_{sc} of the compressed steel bar ranges from 0 to 3.49%, the stirrup ratio ρₛᵥ ranges from 0 to 0.5%, the shear span ratio λranges from 1.9 to 3.1, the concrete strength grade f_{co} ranges from 20 to 50 MPa, and the longitudinal reinforcement ratio ρₛₜ of tensile steel bar ranges from 3% to 4.5%; and
step five: based on a numerical simulation result in step four, an increment of shear strength caused by the compressed steel bar is significantly affected by two factors: the reinforcement ratio ρₛᵥ of the compressed steel bar and the shear span ratio λ, and other factors are ignored; obtaining a mathematical model of the increment of the shear strength via regression analysis.

FIGS. 9A-9H are schematic diagrams of an effect of different reinforcement ratios of the compressed steel bars on a longitudinal strain profile of concrete under peak load of beams.

FIGS. 10A-10D are schematic diagrams of an effect of different parameters on the shear strengths of beams with different reinforcement ratios of the compressed steel bars.

The mathematical model is:

$${V}_{sc} = {48.32}_{SC} ( - {λ}^{2} + 5.14 λ - 5.78 ) {b}_{w} d \geq 0$$

in this formula:
V_{sc} is the increment of the shear strength;
λ is the shear span ratio;
ρ_{sc} is the reinforcement ratio of the compressed steel bar, and
the application scope of the model is: the reinforcement ratio ρ_{sc} of the compressed steel bar ranges from 0 to 3.49%, the shear span ratio λ ranges from 1.66 to 3.48, and the concrete strength grade f_{co} ranges from 20 to 50 MPa.

The test method in step one is as follows:

### Preparation of Specimens

Six reinforced concrete beam specimens, each of which has a cross-section of 180 mm (width)×300 mm (depth) and a length of 1600 mm, are used to evaluate the effect of reinforcement of the compressed steel baron the shear performance of the RC beams.

All beams have the same longitudinal tension reinforcement, but the compressed steel bars and stirrups are different. Beam specimens are divided into two series: the series I includes two beams without stirrups; and series II consists of four beams with stirrups with a spacing of 200 mm and a diameter of 8 mm. For each design, two identical beam specimens of the series II are manufactured. The two beam specimens are reinforced with two steel bars with a diameter of 8 mm as the top longitudinal reinforcement. The other two beam specimens use three steel bars with a diameter of 20 mm as the top longitudinal reinforcement. In series II, each beam specimen uses three steel bars with a diameter of 25 mm as the bottom longitudinal reinforcement.

FIG. 2 is a schematic diagram of an arrangement of steel bars of four beam specimens in series II of a step of experimental testing.

Table 1 lists information on the beam specimens. The identification of each beam specimen is as follows: (1) the characters NS or S before the hyphen indicate the beam without stirrups and the beam with stirrups respectively; (2) the Arabic numerals after the hyphen indicate the reinforcement ratio of the compressed steel bar; and (3) the Arabic numerals after the second hyphen distinguish two beams with the same design in the series II. For example, NS-2.01 refers to a RC beam with a reinforcement ratio of a compressed steel bar of 2.01% without stirrups. The mixture proportion of concrete is listed in Table 2. The maximum aggregate size of concrete is 20 mm. Several concrete cubes with a dimension of 150×150×150 mm were tested under uniaxial compression to determine the strength of concrete. The measured average compressive strength (f_{cu}) of concrete during the beams were tested is 45.9 MPa. The yield strength, elastic modulus and tensile strength of steel bar with different diameters are listed in Table 3. The mixture proportion of concrete is shown in Table 2.

TABLE 1
Information on the beam specimens in the current study.

| | | | | | Longitudinal | Longitudinal | |
|---|---|---|---|---|---|---|---|
| | | | | | tension | compression | Transverse |
| | Specimen | Depth | Width | Length | reinforcement | reinforcement | reinforcement |
| Series | ID | (mm) | (mm) | (mm) | (mm) | (mm) | (mm) |
| I | NS-0.21 | 300 | 180 | 1600 | 3T25 | 2T8 | — |
| | NS-2.01 | 300 | 180 | 1600 | 3T25 | 3T20 | — |
| II | S-0.21-1 | 300 | 180 | 1600 | 3T25 | 2T8 | T8@100 |
| | S-0.21-2 | 300 | 180 | 1600 | 3T25 | 2T8 | T8@100 |
| | S-2.01-1 | 300 | 180 | 1600 | 3T25 | 3T20 | T8@100 |
| | S-2.01-2 | 300 | 180 | 1600 | 3T25 | 3T20 | T8@100 |

TABLE 2
Mixture proportion of concrete.

| Matrix | | | Coarse | |
|---|---|---|---|---|
| designation | Cement | Sand | aggregate | Water |
| Concrete | 1.0 | 1.9 | 3.68 | 0.53 |

TABLE 3
Material properties of the steel bars.

| | Elastic | | |
|---|---|---|---|
| Diameter | modulus | Yield strength | Ultimate strength |
| (mm) | Eₛ (GPa) | f_{y} (MPa) | fₛᵤ (MPa) |
| 8 | 204 | 427 | 657 |
| 20 | 204 | 417 | 585 |
| 25 | 198 | 428 | 635 |

### Test Settings

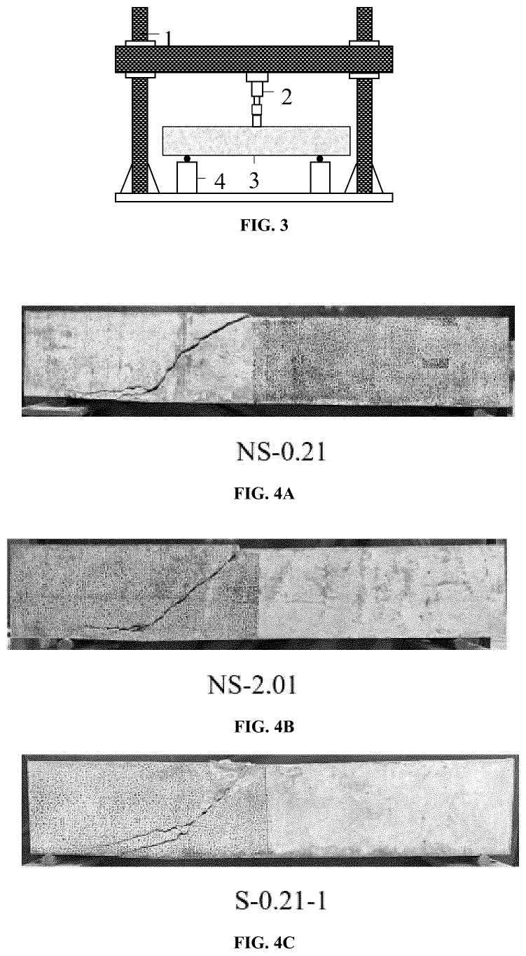

All beams were loaded by three-point bending. The distance from the loading point to each of the supports 4 at both ends was 650 mm (as the shear span). The shear span ratio is 2.5, two of the three displacement sensors were installed on the supports and the other was placed in the middle span, all three of which are used to measure displacement. The load was applied by a hydraulic jack 2. The support consists of two steel rollers. A steel gasket with 180×50×5 mm was arranged between the roller and the concrete surface to prevent stress concentration. The schematic diagram of the three-point bending test is shown in FIG. 3. A preload was first used to check the reliability of the instrument and was set to 10% of the predicted limit load. After preloading, a load was applied every 10 kN, and each load level was kept for about 1 minute, test phenomenon was observed and test data is recorded. When an actual loading load reached 75% of a predicted peak value, the loading interval was reduced to 5 kN. When obvious shear crack and a significant drop in load were observed, the test was terminated. All test data was collected in real time by data acquisition instrument.

### Failure Mode and Crack Mode

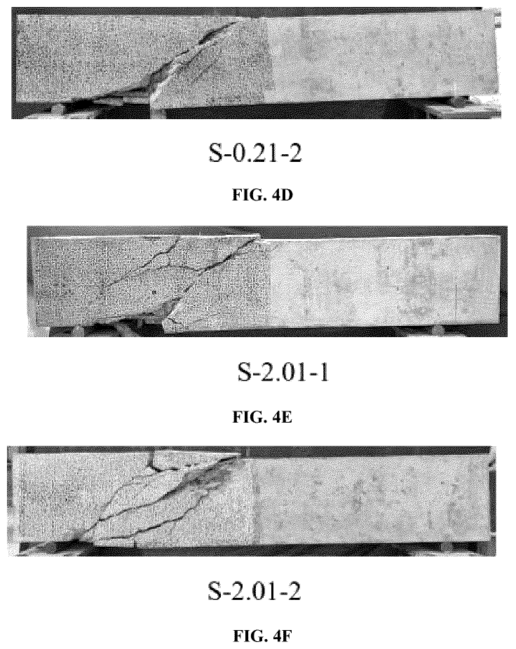

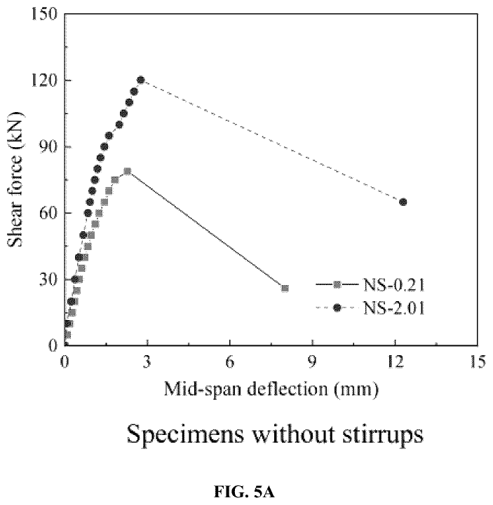

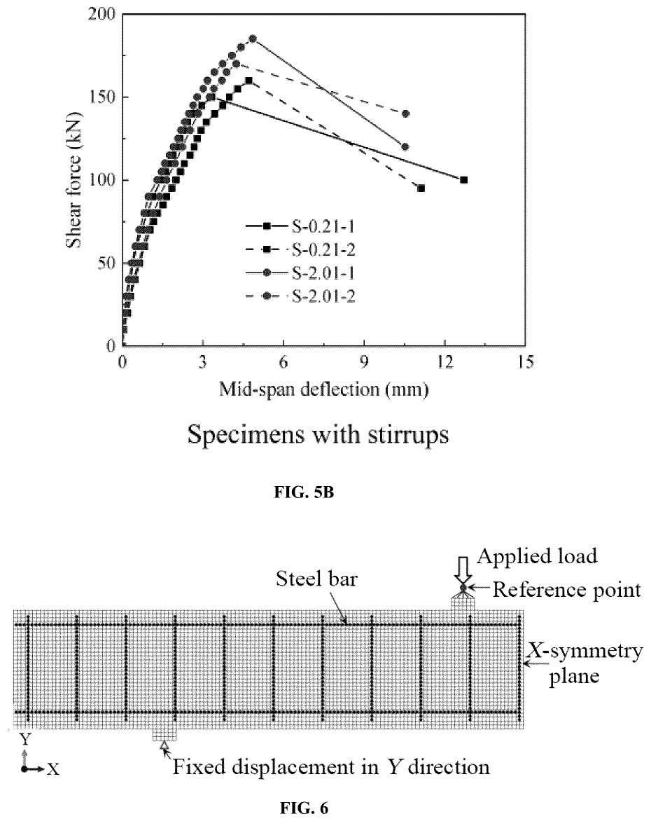

Brittle failure will be occurred in all beams. The failure mode and crack morphology of the test beams are shown in FIGS. 4A-4F. FIGS. 5A-5B is a diagram of shear-deflection curves drawn according to a test result. The NS-0.21 specimen is a reinforced concrete beam without stirrups having an initial cracking load of 40.2 kN (shear force=20.1 kN). Before reaching the limit load, a small bending crack was appeared at the bottom of the middle span, and no oblique crack was appeared in the shear bending area. When the load reaches 157.8 kN, a crack quickly was appeared from the support 4 to the loading point, and the load dropped sharply due to this oblique crack, and the beam was suddenly cut off. The mid-span deflection of NS-0.21 specimen at the beginning of shear failure was 2.28 mm. The final crack morphology of NS-0.21 is shown in FIG. 4A.

The NS-2.01 specimen and NS-0.21 specimen had the same geometric dimensions and the bottom longitudinal reinforcement, but have a larger compression longitudinal reinforcement. The NS-2.01 also presented shear failure mode, as shown in FIG. 4B. It is worth noting that in the limit state of NS-2.01, concrete was crushed and peeled off at the loading point, while NS-0.21 is not crushed and peeled off. Compared with NS-0.21, the oblique crack in NS-2.01 appeared earlier and developed more slowly.

The S-0.21-1 and S-0.21-2 are reinforced concrete beams with stirrups. Under the load of 160.2 kN, diagonal cracks appeared in the shear bending area of S-0.21-1. With the further increase of external load, the cracks extended to the loading point. With the increase of beam deflection, the number and width of oblique cracks gradually increased. When the load reaches about 300.0 kN and 320.0 kN, the specimens S-0.21-1 and S-0.21-2 reached the limit state respectively, and at the same time, the bottom longitudinal steel bar was exposed and the concrete peeled off near the critical oblique joint. The oblique cracks ran through the whole beam section. The mid-span deflection of S-0.21-1 beam and S-0.21-2 beam under peak load was 3.3 mm and 4.7 mm respectively, which is more than 1.5 times that of NS-0.21 beam, indicating that the existence of stirrups caused good deformation capacity. The final crack morphologies of S-0.21-1 and S-0.21-2 are shown in FIG. 4C and FIG. 4D.

### Mechanism Analysis of Truss Model in Step One

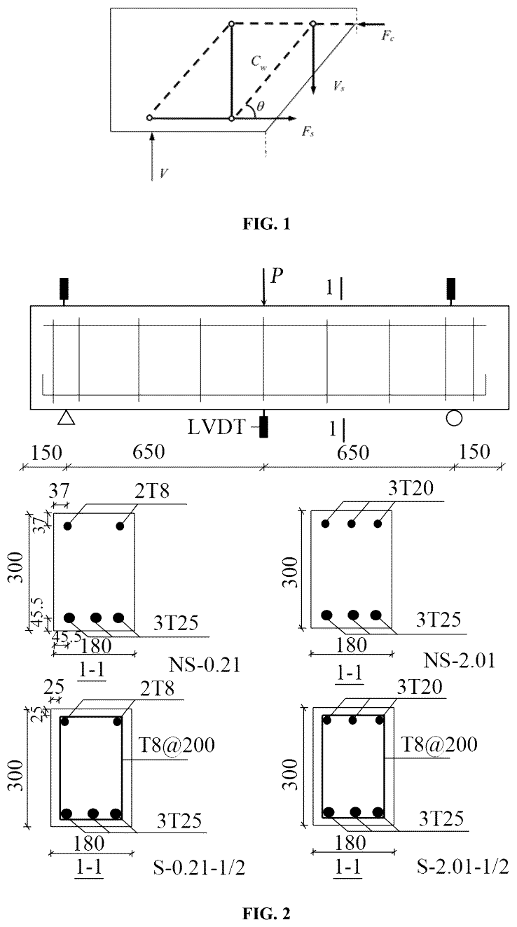

The effect of compressed steel bar on the shear strength of RC beam was analyzed using a conventional truss model. FIG. 1 is a schematic diagram of a truss model, wherein a concrete compressed area is the upper chord (F_{c}), a tension steel bar is the lower chord (Fₛ), the web reinforcement is a tension bar (Vₛ), and the concrete between diagonal cracks is a diagonal compression support (C_{w}) of the truss. In the truss model, the change of bearing capacity of web reinforcement Vₛ, the upper chord F_{c} or the diagonal compression support C_{w} may be the reason causing shear failure. There are three typical failure modes of beams with different designs. For a short beam with small shear-span ratio, its shear strength is usually determined by the value of C_{w}. For a slender beam with large shear-span ratio and small stirrup ratio, shear-tensile failure may occur, and its shear strength is mainly determined by Vₛ, while for a slender beam with medium shear-span ratio and large stirrup ratio, it is easy to be damaged under shear and compression, and F_{c} controls the shear strength. In this case, the adding of compressed steel bar can effectively increase F_{c}, thereby improving the shear strength of RC beam under shear and compression failure.

In the step two, a two-dimensional finite element model was used to improve the calculation efficiency. Considering the symmetry of beam model in boundary and geometric conditions, half of the beam structure was selected for analysis. The FE model of simply supported beam is shown in FIG. 6. The mid-span section was symmetrical to both sides of the beam in the X direction, while the center of the bottom support was constrained to move in the Y direction, and two steel plates (180×50×5 mm) were distributed between the load and the support position to avoid stress concentration. Assuming that there is a perfect combination between the concrete and the steel plates, it is realized by tie option in Abaqus. Through a coupling option in Abaqus, a reference point was created to control loading surface. The vertical displacement was directly applied to the reference point. The mesh size of the model was 10 mm for both the concrete and the steel bar, based on a rigorous mesh convergence study. Because shear problems involve local instability, such as concrete cracking and steel bar deboning, static analysis methods often cannot converge (Rena and Ruiz 2006; Chen et al. 2011, 2012). Therefore, the dynamic analysis method of explicit time integration was used to solve the problem numerically, which had been proved to be an effective method to overcome the convergence problem and maintain high accuracy (Chen et al. 2015; Lin and Wu 2016). The densities of the concrete and the steel bar were 2500 and 7800 kg per cubic meter respectively. The damping ratio was set to 0.05. According to extensive sensitivity study of Chen et al. (2015), the appropriate loading time t₀ and time increment size Δt are as follows:

$${t}_{0} = 100 {T}_{1} \\ Δ t = {T}_{1} / 100 \\ {T}_{1} = 2 π / {ω}_{1}$$

in this formula, T₁ is natural vibration period of the beam; and @1 is characteristic frequency, which is obtained from the eigenvalue analysis of the finite element model.

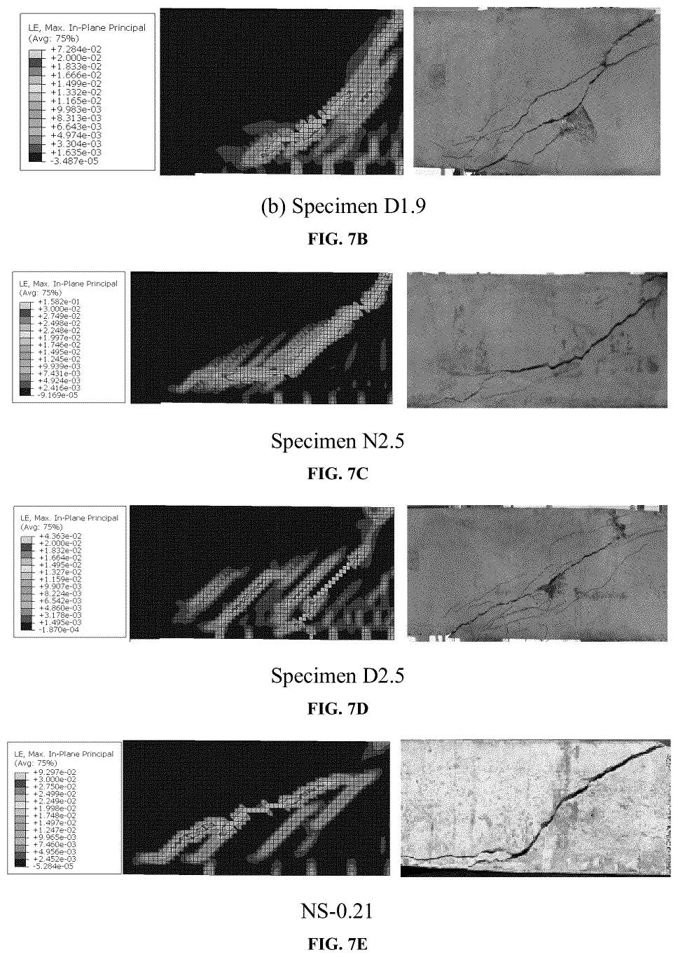

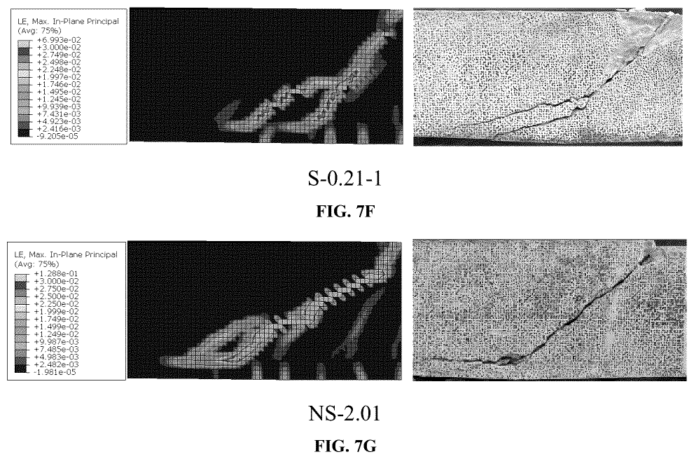

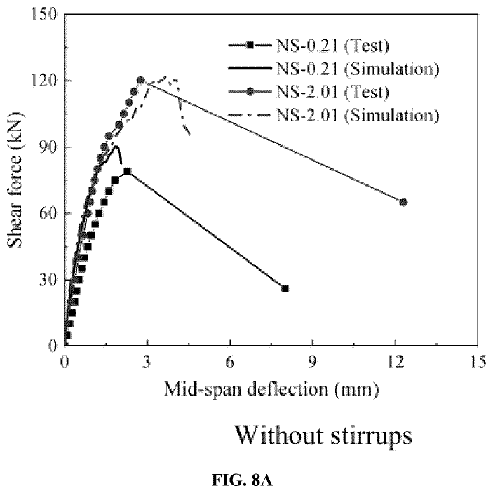

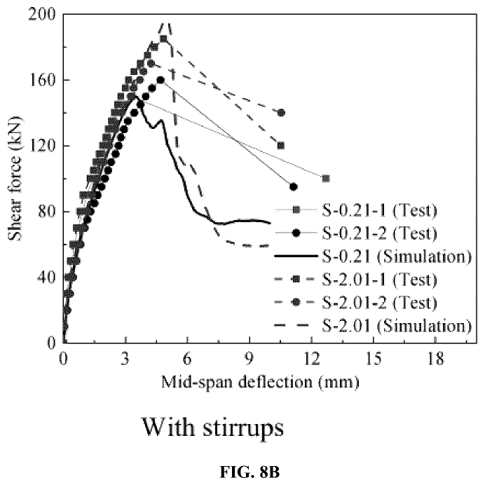

FIGS. 7B-7G are comparison diagrams of failure modes of a finite element simulation result and a test result, comparison diagrams of shear-deflection curves of a test result and a finite element simulation result is shown in FIGS. 8A-8B, and the shear strength obtained by the finite element simulation was equivalent to the measured value. The average ratio between simulated and measured shear strength values was 1.05, and the standard deviation was 7.87%, which verifies the reliability of the finite element model, and the finite element model can accurately predict the shear strength of the specimen.

In this disclosure, specific examples are used to explain the principle and implementation of the disclosure, and the description of the above examples is only used to help understand the method and core idea of the disclosure; at the same time, for those skilled in the art, according to the idea of the disclosure, there will be changes in the specific implementation and application scope. In summary, the contents of this specification should not be construed as limiting the present disclosure.

What is claimed is:

1. A method for strengthening shear strength of a RC beam with a compressed steel bar, comprising:
step one: analyzing and concluding that the compressed steel bar has a positive effect on the shear strength of the RC beam via one or both of experimental testing and establishing a truss model;
step two: establishing a finite element model using simulation software in a computer, and carrying out a finite element simulation;
step three: comparing a result obtained by the finite element simulation with that obtained by the experimental testing, so as to verify a reliability of the finite element model;
step four: performing a systematic research about a comprehensive impact of a reinforcement ratio ρ_{sc} of the compressed steel bar, a stirrup ratio ρₛᵥ, a reinforcement ratio ρₛₜ of a tensile longitudinal steel bar, a shear span ratio/and a concrete strength grade f_{co} on the shear strength of the RC beam, via analyzing numerical parameters; and
step five: obtaining a mathematical model of an increment of the shear strength via regression analysis based on a numerical simulation result in step four.

2. The method for strengthening shear strength of a RC beam with a compressed steel bar according to claim 1, wherein in the step five, the increment of the shear strength caused by the compressed steel bar is significantly affected by two factors: the reinforcement ratio ρ_{sc} of the compressed steel bar and the shear span ratio λ, and other factors are ignored; and the mathematical model of the increment of the shear strength affected by the reinforcement ratio ρ_{sc} of the compressed steel bar and the shear span ratio λ is obtained via the regression analysis.

3. The method for strengthening shear strength of a RC beam with a compressed steel bar according to claim 2, wherein in the step five, the mathematical model of the increment of the shear strength is:
$${V}_{sc} = {48.32}_{SC} ( - {λ}^{2} + 5.14 λ - 5.78 ) {b}_{w} d \geq 0$$
in this formula:
V_{sc} is the increment of the shear strength;
λ is the shear span ratio;
ρ_{sc} is the reinforcement ratio of the compressed steel bar;
b_{w} is an effective width of the beam; and
d is an effective height of the beam.

4. The method for strengthening shear strength of a RC beam with a compressed steel bar according to claim 1, wherein in the step two, the used simulation software is Abaqus software.

5. The method for strengthening shear strength of a RC beam with a compressed steel bar according to claim 1, wherein in the step four, a control variable method is used in the systematic research, when one factor is considered, other factors remain unchanged.

6. The method for strengthening shear strength of a RC beam with a compressed steel bar according to claim 1, wherein in the step four, the reinforcement ratio ρ_{sc} of the compressed steel bar ranges from 0 to 3.49%, the stirrup ratio ρₛᵥ ranges from 0 to 0.5%, the shear span ratio λranges from 1.9 to 3.1, the concrete strength grade f_{co} ranges from 20 to 50 MPa, and the reinforcement ratio ρₛₜ of the tensile longitudinal steel bar ranges from 3% to 4.5%.
